(19) United States
(12) Patent Application Publication
(10) Pub. No.: US 2026/0247511 A1
(43) Pub. Date: Aug. 20, 2026

(54) LED LIGHTING CIRCUIT AND LED LUMINAIRE COMPRISING THE SAME

(71) Applicant: SIGNIFY HOLDING B.V., EINDHOVEN (NL)

(72) Inventor: LIWEN ZHOU, SHANGHAI (CN)

(21) Appl. No.: 18/995,247

(22) PCT Filed: Jul. 12, 2023
(86) PCT No.: PCT/EP2023/069268

§ 371 Date: Jan. 16, 2025

(30) Foreign Application Priority Data
Jul. 21, 2022 (WO) PCT/CN2022/107171
Aug. 29, 2022 (EP) 22192539.9

(51) Int. Cl. H05B 45/48

(52) U.S. Cl. CPC H05B 45/48

(57) ABSTRACT

Provided an LED lighting circuit comprising a current regulator (I1) adapted to provide a regulated current (I); a LED string comprising at least two LED units (D1, D3) connected in series, to receive the regulated current (I); a switch (S1) in parallel with one LED unit (D1) of the at least two LED units (D1, D3), said switch (S1) is adapted to be controlled to be close to bypass the regulated current (I1) from the one LED unit (D1), or to be open to allow the regulated current (I1) into the one LED unit (D1); an output capacitor (C1) in parallel with the LED string; and a controlling circuit coupled to the switch (S1) and adapted to operate said switch (S1) to be close or open; characterized in that the controlling circuit is further adapted to operate said switch (D1) in a current regulation mode to conduct a current (I′) with a certain deviation from the regulated current (I) so as to adjust the voltage on the output capacitor (C1), before operates said switch (S1) to be close or open.

### FIELD OF THE INVENTION

The present invention relates to the field of led lighting circuits.

### BACKGROUND OF THE INVENTION

FIG. 1 shows a common topology of driving apparatuses for LEDs. An overall current regulator/current source I1 generates a current I to power a LED string comprising LED units D1 and D3 connected in series. The current regulator/current source could be a single PFC stage, or a hysteresis-controlled DC-DC stage, and therefore the current I1 is not a 100% constant current but with a certain ripple. A relatively large output capacitor is placed in parallel with the LED string to smooth the ripple. At least one LED unit D1, which may comprise one or more LED chips, in the LED string is in parallel with a switch M2, called as a shunt switch, and the shunt switch selectively closes, by entering saturation mode, or opens, by entering cut off mode, to selectively bypass or not bypass the parallel LED unit D1 so as to adjust whether the current I1 flows into the LED unit D1 or the shunt switch. By doing so, the output of the LED unit D1 can be dynamically changed while the remaining LED unit D3, which may comprise one or several LED chips, is not influenced and is always powered by the current I. In FIG. 1 the current regulator I1 is floating from the ground, and the shunt switch M2 and LED D1 are connected to the positive output of the current regulator I1. The shunt switch M2 is a PMOS transistor. A grounded controlling circuit/gate driver for the PMOS transistor M2 is provided. The controlling circuit comprises a resistor R2, a resistor R1 and a NMOS transistor M1 connected between the positive output of the floating current regulator and the ground. The interconnection of the resistors R2 and R1 is connected to the gate of the PMOS transistor M2. In an alternative embodiment in which the current regulator I1 is grounded, an NMOS can be used to implement the shunt switch. Please be noted that FIG. 1 is just an example, and alternatively the current regulator may be grounded/not floating. DE102017200490B3 discloses such a topology.

A problem with such topology is that the voltage on the output capacitor C1 would be different from the effective voltage of the LED string at the moment some LEDs are shunted or restored to a non-shunted state. Specifically, assume at first the switch M2 is open to allow both LED units D1 and D3 to be powered by the current I1. Thus the voltage on the capacitor C1 equals to the sum of the forward voltages of the LED units D1 and D3. When PMOS M2 is closed so as to shunt/disable the LED unit D1, the voltage on the capacitor C1 is much higher than the forward voltage of the remaining LED unit D3, and therefore an inrush current goes through PMOS switch M2 and the remaining LED unit D3. The inrush is much higher than the original current and would cause the LED D3 to flicker. FIG. 2 shows the current curve wherein the original current of 280 mA rises to around 370 mA. Similarly, a dip in the current occurs when the shunt switch PMOS M2 is open as shown in FIG. 3. Assume at first the switch M2 is open, bypassing the LED unit D1 and allowing only the LED unit D3 to be powered by the current I1. Thus the voltage on the capacitor C1 equals to the forward voltages of the LED unit D3. When PMOS M2 is open so as to enable/unshunt the LED unit D1, the voltage on the capacitor C1 is much lower than (imbalance) the sum of forward voltages of the LED units D1 and D3, and it has difficulty to turn on the two LED units D1 and D3 and the LED current drops significantly from 280 mA to only 30 mA. The current recovers to I1 when the voltage across capacitor C1 reaches the sum of forward voltages of the LED units D1 and D3. The LED unit D3 has flicker in its light output. In case that the LED units D1 and D3 have different lighting functions or are spatially displaced from each other, such flicker is visible by people and is not preferred.

WO2021/198349A1 proposes a solution to solve such voltage imbalance during shunt switching. WO2021/198349A1 has a dedicated circuit comprising a switch, a capacitor and a resistor to discharge a capacitor in parallel with all LEDs when some of the LEDs is shunted. US20120299489A1 also discloses a topology comprising a output capacitor, a string of LEDs, and bypass switches respective in parallel with each LED. US20120299489A1 further has a dedicated capacior charging constant current portion in series with the capacitor for charging and discharging the capacitor.

### SUMMARY OF THE INVENTION

The invention is defined by the claims.

The applicant finds that the WO2021/198349A1 needs the dedicated circuit to discharge the capacitor, and this increases the component number and cost. Further, the energy discharged from the output capacitor is dissipated by the resistor in the circuit, and this increases power loss.

A basic idea of the present application is that before operating the shunt switch into close state or open state so as to shunt/unshunt an LED unit in the LED string, re-using the shunt switch (and the remaining LED unit) to discharge or charge the output capacitor so as to regulate the voltage on the output capacitor from the original effective voltage of the LED string to the target effective voltage of the LED string. The shunt switch is operated in the active (linear) mode, wherein providing a controlling circuit to actively control the shunt switch to conduct a switch current different from the output current of the current regulator, the differential current between the switch current and the output current relates to the output capacitor and adjust the voltage on the output capacitor to reach the target voltage.

Under the above basic idea, a first aspect of the invention provides a LED lighting circuit comprising a current regulator adapted to provide a regulated current; a LED string comprising at least two LED units connected in series, to receive the regulated current; a switch in parallel with one LED unit of the at least two LED units, said switch is adapted to be controlled to be close to bypass the regulated current from the one LED unit, or to be open to allow the regulated current into the one LED unit; an output capacitor in parallel with the LED string; and a controlling circuit coupled to the switch and adapted to operate said switch to be close or open; characterized in that the controlling circuit is further adapted to operate said switch in a current regulation mode to conduct a current with a certain deviation from the regulated current so as to adjust the voltage on the output capacitor, before operating said switch to be close or open.

Re-using the shunt switch for regulating the voltage on the output capacitor mitigates the need for a dedicated circuit to discharge the output capacitor in the above cited prior art, and reduces the complexity/cost of the LED lighting circuit. Further, the shunt switch conducts current to the remaining LED unit thus the remaining LED unit helps to consume the energy in the output capacitor to regulate the voltage, thus less energy is wasted and efficiency is improved compared with the above cited prior art.

In a further embodiment, the switch is a semiconductor transistor and the controlling circuit is adapted to operate said switch in the active mode as the current regulation mode to conduct the current with the certain deviation from the regulated current,
operate said switch in the saturation mode as close, and operate said switch in the cut off mode as open.

A semiconductor transistor is a common and low cost component to implement the three modes. Besides, it is also simple and low cost to implement the controlling circuit that drives the semi-conductor transistor in the three modes. Thus this embodiment has the advantage of low cost.

In a further embodiment, the controlling circuit is adapted to change the voltage of the output capacitor from an original effective forward voltage of the LED string before the switch is operated to a target effective forward voltage of the LED string in case that said switch is operated close or open, and then operate said switch close or open.

In this embodiment, the voltage of the output capacitor is regulated to match the new effective forward voltage of the LED string to be driven by the output capacitor when the switch is to be closed or open. The voltage imbalance is mitigated because the voltage across the output capacitor is gradually being changed to the voltage of the LED string after the switch has changed its state, and it prevents an inrush or a dip in the current. Here the target effective forward voltage in case that the operation of the switch changes from close to open or vice versa, resulting in a new sum of the forward voltage of the LED unit(s) that will be driven by the current, excluding the LED units that will be shunted by the switch.

Preferably, a voltage sensing circuit is provided to sense the voltage on the output capacitor, and a comparing circuit is provided to compare the voltage on the output capacitor with a prestored value of the target effective forward voltage. If the difference is less than a threshold, meaning the voltage on the output capacitor has been regulated substantially same with the to-be forward voltage, the controlling circuit operate the switch to exit the active mode to the saturation on mode or cut off mode and proceed to the normal shunting/non-shunting function.

In a specific embodiment, in order to balance the capacitor voltage in non-shunting state and the LED string voltage in shunting state, the controlling circuit is adapted to operate the switch to conduct the current larger than the regulated current, thereby the output capacitor is discharged so as to decrease the voltage on the output capacitor, preferably to a forward voltage of a LED unit in series connection with the switch, before operating said switch to be close.

In this embodiment, since the current through the switch is larger than the current from the current regulator, the output capacitor has to discharge to provide the differential current and in turn the voltage on the output capacitor decreases. This embodiment provides an effective way to decrease the voltage and match the voltage to the forward voltage of the LED string in shunting state.

In another specific embodiment, in order to balance the capacitor voltage in shunting state and the LED string voltage in non-shunting state, the controlling circuit is adapted to operate the switch to conduct the current smaller than the regulated current, thereby the output capacitor is charged so as to increase the voltage on the output capacitor, preferably to a forward voltage of the at least two LED units, before operates said switch to be open.

In this embodiment, since the current through the switch is smaller than the current from the current regulator, the differential current flows into and charge the output capacitor and in turn the voltage on the output capacitor increases. This embodiment provides an effective way to increase the capacitor voltage and match the voltage to the forward voltage of the two LED units in non-shunting state.

In a specific implementation, the certain deviation is 5% to 30% of the amplitude of the regulated current.

In this implementation, the at least 5% difference adjusts the voltage on the output capacitor in time, and at most 30% difference prevents human-visible flicker on the LED unit that still works. This range can achieve balance between fast response and low flicker.

In a further embodiment, the LED lighting circuit further comprises an interface adapted to receive a light setting command, and said controlling circuit is adapted to operate said switch according to the light setting command.

In a specific embodiment, said at least two LED units have different lighting functions, and said light setting command is adapted to select one or both of the at least two LED units to operate.

In a further specific embodiment, the LED unit in parallel with the switch is for illuminating and the LED unit in series with the switch is for generating an ambient light.

These embodiments apply the invention in scene/function switchable lighting, such that the flicker during the lighting scene/function switching can be avoided.

In a second aspect, it provides a LED luminaire comprising the LED lighting circuit according to the above aspect and embodiments.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a LED lighting circuit with two LED units and one shunt switch in parallel with one LED unit;

FIG. 2 shows the LED current waveform when the shunt switch is close;

FIG. 3 shows the LED current waveform when the shunt switch is open;

FIG. 4 shows a LED lighting circuit according to an aspect of the present application;

FIG. 5a shows an equivalent circuit of the LED lighting circuit in FIG. 4 when the shunt switch is to be closed to shunt one LED unit;

FIG. 5b shows an equivalent circuit of the LED lighting circuit in FIG. 4 when the shunt switch has been closed;

FIG. 6 shows the LED current waveform of FIGS. 5a and 5b;

FIG. 7a shows an equivalent circuit of the LED lighting circuit in FIG. 4 when the shunt switch is to be opened to not shunt one LED unit;

FIG. 7b shows an equivalent circuit of the LED lighting circuit in FIG. 4 when the shunt switch has been opened;

FIG. 8 shows the LED current waveform of FIGS. 7a and 7b; and

FIG. 9 shows an implementation of the LED lighting circuit in FIG. 4.

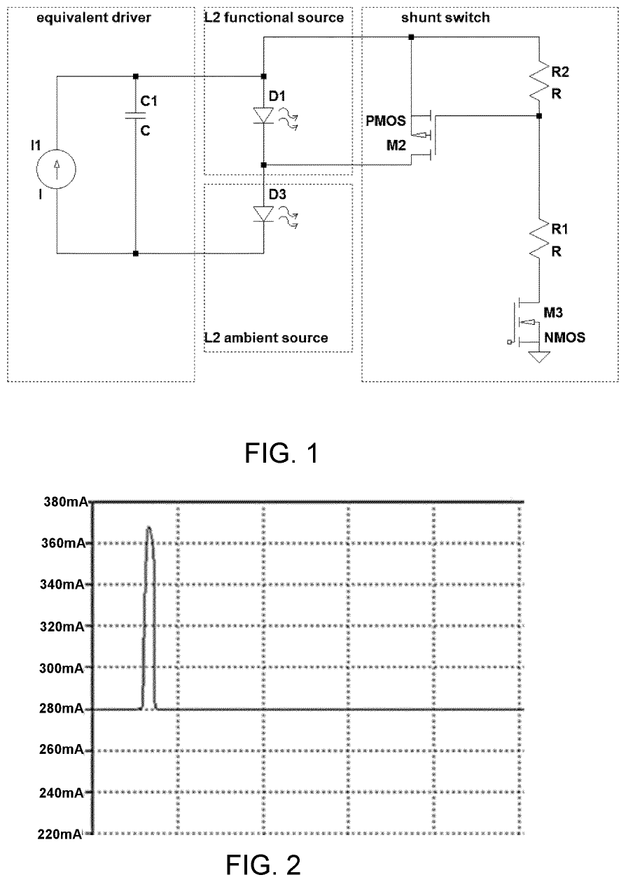

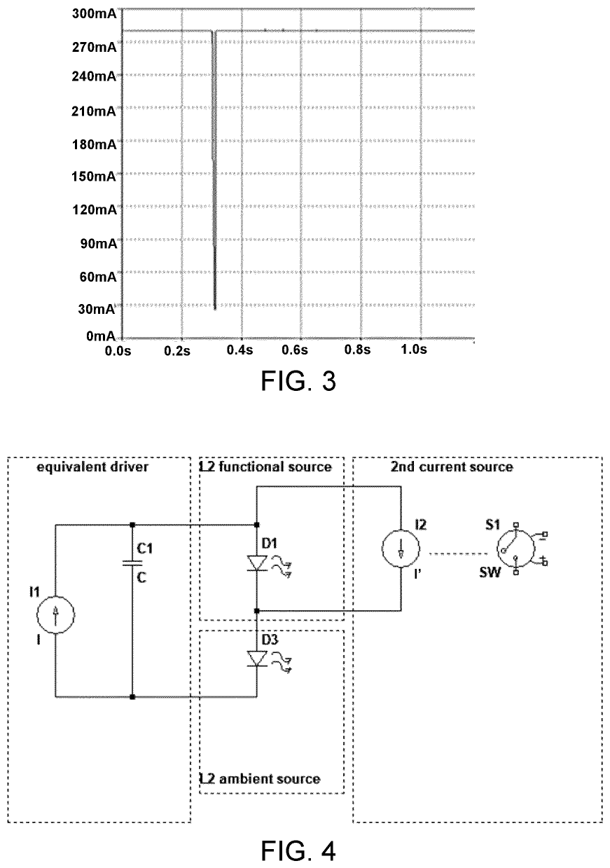

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

As shown in FIG. 4, a first aspect of the invention provides a LED lighting circuit comprising a current regulator I1 adapted to provide a regulated current I; a LED string comprising at least two LED units D1, D3 connected in series, to receive the regulated current I; a switch S1 in parallel with one LED unit D1 of the at least two LED units, said switch S1 is adapted to be controlled to be closed to bypass the regulated current I from the one LED unit D1, or to open to allow the regulated current I into the one LED unit D1; an output capacitor C1 in parallel with the LED string; and a controlling circuit, not shown, coupled to the switch S1 and adapted to operate said switch S1 to be open or closed; characterized in that the controlling circuit is further adapted to operate said switch S1 in a current regulation mode, in other words as a current regulator/current source 12, to conduct a current I′ with a certain deviation from the regulated current I so as to adjust the voltage on the output capacitor C1, before operates said switch S1 to be close or open.

More specifically, in a transition state between not shunting and shunting one LED unit, the controlling circuit operates the switch S1 to draw the current I′ so as to change the voltage of the output capacitor C1 from an original effective forward voltage of the LED string before the switch is operated to a target effective forward voltage of the LED string in case that said switch has been operated, and then the controlling circuit operates the switch S1 to shunt or not shunt the LED unit D1. Thus the capacitor voltage has been regulated close to the effective LED string voltage when the shunt switch S1 is operated, and there is less flicker in the LED current when the shunt switch connects the output capacitor to the LED units in the target state.

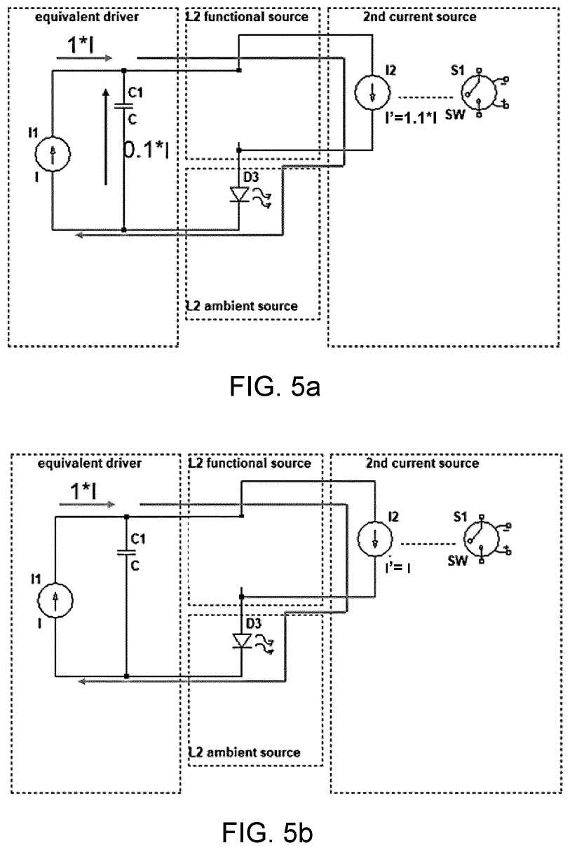

Now the description will explain how the embodiment works in the transition from not shunting to shunting, by using FIGS. 7a, 5a, 5b and 6.

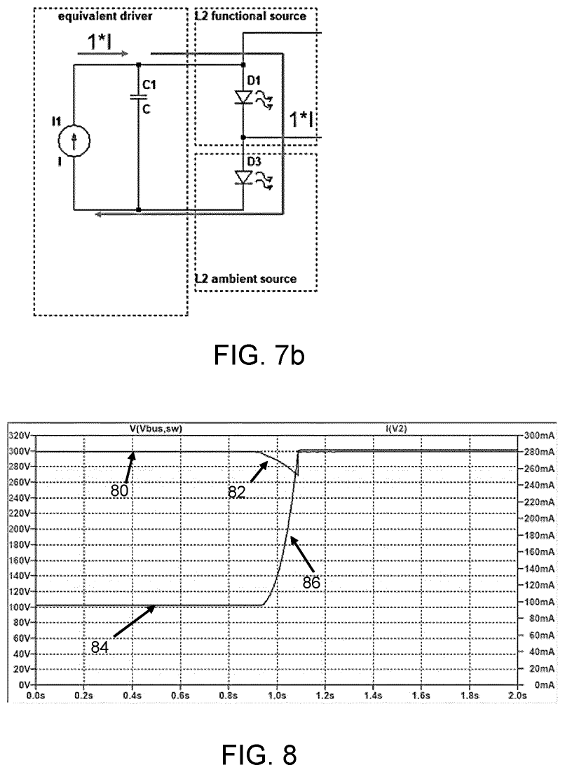

Assume the switch S1 is open for not shunting the LED unit D1 in the beginning. The current regulator I1 outputs the desired current I. The capacitor C1 has been charged to the effective forward voltage of the LED string, namely the sum of the forward voltages of the LED units D1 and D3. All the current I flows through the LED units D1 and D3. This is illustrated in FIG. 7b.

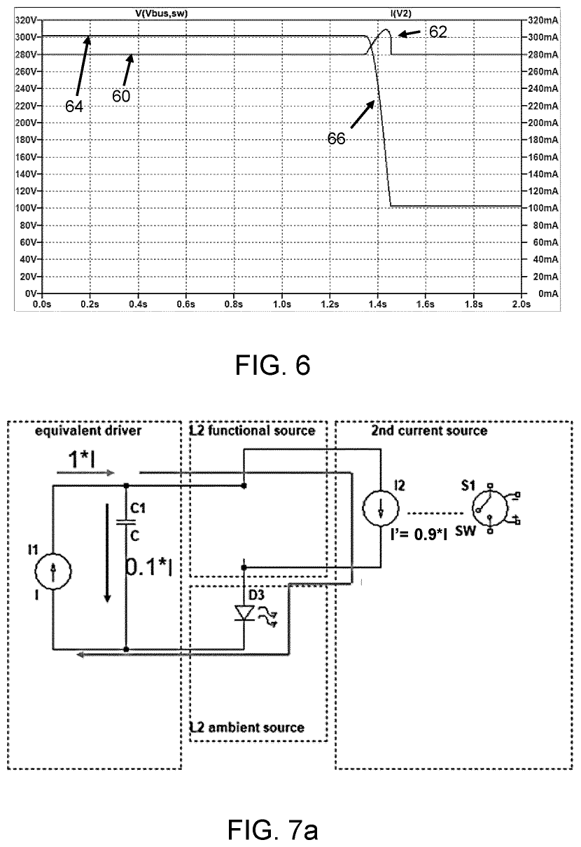

A light setting command is sent to the LED lighting circuit to turn off the LED unit D1, preferably via an interface of the LED lighting circuit. The controlling circuit operates the switch S1 in active mode/current regulation mode, and makes the switch S1 into a current regulator 12 to draw a current I′ larger than the current I. This can be seen by the small uprise portion 62 in the curve 60 of the LED unit D3 current in FIG. 6. The current I′ may be from 1.05 to 1.3 times the current I. The embodiment uses 1.1 as an example. As shown in FIG. 5a, the differential current of the switch current 1.1*I and the output current I from the current regulator I1 is 0.1*I, and the output capacitor has to provide this differential current. For ΔU=ΔQ/C wherein ΔU is the voltage change on the capacitor, C is the capacitance of the capacitor, and ΔQ is the charge change on the capacitor, the voltage on the capacitor C1 will be decreased by 0.1*I*t/C wherein t is the discharge time for which the switch draws the 1.1*I current. The curve 64 in FIG. 6 shows the voltage on the capacitor C1, and the downward slope 66 shows the decreasing of the voltage due to the discharging by the switch S1.

In the above embodiment, in condition of the 0.1*I current discharged away from the capacitor, this capacitor can be discharged to a sufficient low voltage in only around 100 ms. And a slight increasing of the LED unit D3's current is just 10% percent and won't cause uncomfortable flicker at the user. Please note that this parameter is just an example and is not the only applicable parameter, and those skilled in the art may design different parameter to achieve a good balance between low flicker and fast voltage regulation.

As the capacitor voltage is decreased close to the forward voltage of the LED unit D3, the controlling circuit can operate the switch S1 into saturation mode and the conduction current I′ is equal to I, as shown in FIG. 5b.

Now the description will explain how the embodiment works in the transition from shunting to not shunting, by using FIGS. 5b, 7a, 7b and 8. Assume the switch S1 is closed for shunting the LED unit D1 in the beginning. The current regulator I1 outputs the desired current I. The capacitor C1 has been charged to the effective forward voltage of the LED string, namely only the forward voltages of the LED unit and D3. All the current I flows through the LED unit D3. This is much like FIG. 5b's illustration.

A light setting command is sent to the LED lighting circuit to turn on the LED unit D1. The controlling circuit operates the switch S1 in active mode and into a current regulator 12 to draw a current I′ smaller than the current I, as shown by the small dip portion 82 in the curve 80 of the LED unit D3 current in FIG. 8. The current I′ may be from 0.7 to 0.95 times the current I. The embodiment uses 0.9 as an example. As shown in FIG. 7a, the differential current of the switch current 0.9*I and the output current I from the current regulator I1 is 0.1*I, and this differential current has to flow into the output capacitor C1 and charge it. For ΔU=ΔQ/C wherein ΔU is the voltage change on the capacitor, C is the capacitance of the capacitor, and ΔQ is the charge change on the capacitor, the voltage on the capacitor C1 will be increased by 0.1*I*t/C wherein t is the time for which the switch S1 conducts the 0.9*I current. The curve 84 in FIG. 8 shows the voltage on the capacitor C1, and the upward slope 86 shows the increasing of the voltage due to the charging.

In the above embodiment, in condition of the 0.1*I charging current into the capacitor C1, this capacitor C1 can be charged to sufficient voltage in only around 100 ms. And a slight decreasing of the LED unit D3's current is just 10% percent and it won't cause user un-comfortable flicker. Please note that this parameter is not the only applicable parameter, and those skilled in the art may design different parameter to achieve a good balance between low flicker and fast voltage regulation.

As the capacitor voltage is increased to close the sum of the forward voltages of the LED units D1 and D3, the controlling circuit can operate the switch S1 into cut off mode. The conduction current I′ is zero, the current regulator I1 just drives the LED unit D1 and D3 connected in series, and the switch S1 can be effectively ignored, as shown in FIG. 7b.

In one embodiment, to monitor the voltage on the output capacitor C1 and control the switch S1 accordingly, a voltage sensing circuit is provided to sense the voltage on the output capacitor, and a comparing circuit is provided to compare the voltage on the output capacitor with the target value, either the forward voltage of LED units D3 for the shunting case or the sum of the forward voltages of LED units D1 for the non-shunting case. If the difference is less than a threshold, meaning the voltage on the output capacitor C1 has been regulated substantially close to the forward voltage in the new state, the controlling circuit may control the switch to change from the active mode to the closed mode for normal shunting function or to the cut off mode for non-shunting function.

The switch S1 is preferably a transistor, Wherein, the close/saturation on mode means the transistor does not limit the current through it, and just conducts whatever the current provided by an upstream power supply. The cut off mode means the transistor is open and does not conduct any current. The active mode means the current through the transistor is controlled by a signal applied on the base/gate in a linear relationship, and the active mode can also be regarded as the liner mode.

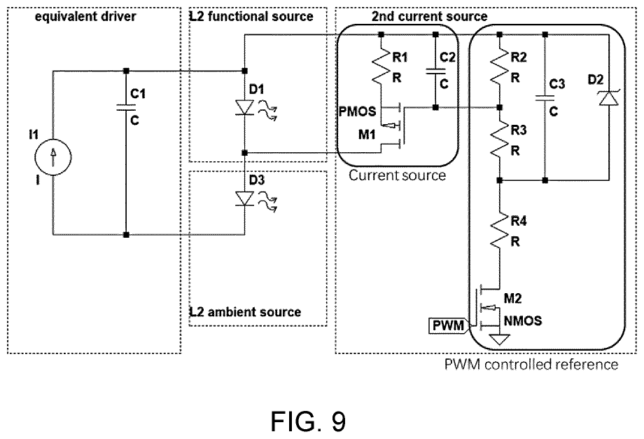

The transistor is preferably a MOSFET transistor. Controlling a MOSFET in the active mode, as well as in the close (saturation on) mode and the cut off mode, can be implemented by controlling the gate voltage of the MOSFET. FIG. 9 gives an example. Current source consists of M1, R1 and C2. Current going through R1 and M1 is adjusted by voltage across over C1. Level shift consists of R2, R3, C3, D2, R4 and M2. C2 voltage is controlled by PWM duty. When PWM duty is 0 (M2 opens always), C2 voltage is zero. And PWM duty is 1 (M1 close always), C2 voltage is clamped by D2 (Vd2). And PWM duty is between 0 and 1, C2 voltage is also between 0 and Vd2 accordingly. For current source, there is a threshold of PMOS (Vpmos). As C2 voltage is lower than Vpmos, PMOS works in cut off mode. No current is bypassed by current source. As C2 voltage is higher than Vpmos and voltage of D1 is higher than C2 voltage, PMOS works in adjustable resistance mode/active mode. D1 current is bypassed by current source and current is set by PWM duty. As C2 voltage is higher than Vpmos and voltage of D1 is lower than C2 voltage, PMOS works in saturation mode. D1 is shorted by PMOS.

In another example, the switch S1 can also be implemented by a BJT transistor. Controlling a BJT transistor in the active mode, as well as in the close/saturation on mode and the open/cut off mode, can be implemented by controlling the base current of the BJT transistor. It is well known for those skilled in the art to design a circuit for controlling the base current of the BJT transistor to reach the three modes, and the description would not give further details.

In an implementation of a scene switchable LED lighting, said at least two LED units have different lighting functions, the LED lighting circuit further comprising an interface adapted to receive a light setting command, and sad controlling circuit is adapted to operate said switch according to the light setting command to as to select one or both of the at least two LED units to operate, thereby to activate different operating scene of the LED lighting.

Preferably, in a large luminaire, the LED unit D1 in parallel with the switch S1 is for illuminating and placed at the center of the luminaire, and the LED unit D3 in series with the switch S1 is for generating an ambient light and placed at rim of the luminaire. Thus, the illuminating function can be selectively activated and de-activated while the ambient lighting is always on. And by using the above embodiment of the invention, visible flicker in the ambient lighting during the scene switching can be avoided.

In the above embodiments, there is only one shunt switch for the LED unit D1. This should not limit the scope of the application. There could be two shunt switches respective for the LED units D1 and D3, wherein each of the two shunt switches is capable of operating as above described to regulate the capacitor voltage.

LED units D1 and D3 just mean to differentiate LEDs that are controlled (shunted) by the switch S1 and those not. Each LED unit D1 and D3 can comprises one or more LED chips.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED lighting circuit comprising:
a current regulator adapted to provide a regulated current;
a LED string comprising at least two LED units connected in series, wherein the LED string is adapted to receive the regulated current;
a switch in parallel with one LED unit of the at least two LED units wherein said switch is adapted to be controlled to be closed to bypass the regulated current from the one LED unit, or to be opened to allow the regulated current into the one LED unit;
an output capacitor in parallel with the LED string; and
a controlling circuit coupled to the switch and adapted to operate said switch to be closed or open;
wherein the controlling circuit is further adapted to operate said switch in a current regulation mode to conduct a current with a certain deviation from the regulated current so as to adjust the voltage on the output capacitor, before operates said switch to be closed or open.

2. The LED lighting circuit according to claim 1, wherein the switch is a semi-conductor transistor, and
the controlling circuit is adapted to:
operate said switch in the active mode as the current regulation mode to conduct the current with the certain deviation from the regulated current,
operate said switch in the saturation mode as closed, and
operate said switch in the cut off mode as open.

3. The LED lighting circuit according to claim 1, wherein the controlling circuit is adapted to
change the voltage of the output capacitor from an original effective forward voltage of the LED string before the switch is operated to a target effective forward voltage of the LED string in case that said switch is arranged to be closed or open, and then
operates said switch to be closed or open.

4. The LED lighting circuit according to claim 1, wherein the controlling circuit is adapted to operate the switch to conduct the current larger than the regulated current, thereby the output capacitor is discharged so as to decrease the voltage on the output capacitor to a forward voltage of a LED unit in series connection with the switch, before operates said switch to be closed.

5. The LED lighting circuit according to claim 1, wherein the controlling circuit is adapted to operate the switch to conduct the current smaller than the regulated current, thereby the output capacitor is charged so as to increase the voltage on the output capacitor to a forward voltage of the at least two LED units, before operates said switch to be open.

6. The LED lighting circuit according to claim 4, wherein the certain deviation is 5% to 30% of the amplitude of the regulated current.

7. The LED lighting circuit according to claim 1, further comprising:
an interface adapted to receive a light setting command, and said controlling circuit is adapted to operate said switch according to the light setting command.

8. The LED lighting circuit according to claim 7, wherein said at least two LED units have different lighting function, and said light setting command is adapted to select one or both of the at least two LED units to operate.

9. A LED lighting circuit according to claim 8, wherein the LED unit in parallel with the switch is for illuminating and the LED unit in series with the switch is for generating an ambient light.

10. A LED luminaire comprising the LED lighting circuit according to claim 1.
